(19) United States
(12) Patent Application Publication
(10) Pub. No.: US 2023/0311116 A1
(43) Pub. Date: Oct. 5, 2023

(54) FLUIDIC DEVICES INCLUDING HYBRID BONDING, AND METHODS OF MAKING THE SAME

(71) Applicant: Illumina, Inc., San Diego, CA (US)

(72) Inventors: Abhishek Kurup, Poway, CA (US); Casey Irvin, Oceanside, CA (US); Sibi Sutty, San Diego, CA (US)

(73) Assignee: Illumina, Inc., San Diego, CA (US)

(21) Appl. No.: 18/187,445

(22) Filed: Mar. 21, 2023

Related U.S. Application Data
(60) Provisional application No. 63/325,756, filed on Mar. 31, 2022.

(51) Int. Cl. B01L 3/00

(52) U.S. Cl. CPC B01L 3/502707; B01L 2300/0848

(57) ABSTRACT

A flow cell can comprise a first substrate; a second substrate; and/or an adhesive layer that couples the first substrate to the second substrate. The adhesive layer can comprise a first adhesive and a second adhesive. A flow channel can be at least partially defined by the first substrate on a flow channel first side, by the second substrate on a flow channel second side opposite the flow channel first side, and by the first adhesive between the first substrate and the second substrate. The first adhesive can be disposed between the flow channel and the second adhesive.

### CROSS-REFERENCE TO RELATED APPLICATION

This application claims the benefit of U.S. Provisional Patent Application No. 63/325,756, filed Mar. 31, 2022 and entitled “Fluidic Devices Including Hybrid Bonding, and Methods of Making the Same,” the entire contents of which are incorporated by reference herein.

### FIELD

This application generally relates to flow cells and methods of making flow cells.

### BACKGROUND

Fluidic channels (e.g., flow cells) are used in many technological applications. For example, certain molecular analyses, such as certain polynucleotide sequencing methods, utilize polynucleotides that are coupled within a flow cell. For example, oligonucleotide primers (e.g., single stranded DNA or ssDNA) can be grafted to a flow channel within a flow cell and used to amplify target polynucleotides for sequencing.

Flow cells can be formed by coupling substrates, which can be formed of, for example, glass or polymeric material, using adhesives, such as pressure sensitive adhesives that are chemically compatible with fluids and compounds within the flow channel. However, such pressure-sensitive adhesives can have bond strengths at levels that can cause or allow peeling or separation between the pressure-sensitive adhesive and a substrate in response to increased pressure or temperature within the flow channel or flow cell. Additionally, shear forces can occur within a flow cell, contributing to the risk of separation between a pressure-sensitive adhesive and a substrate.

### SUMMARY

Examples provided herein are related to fluidic devices including flow cells and methods of making the same. For example, a flow cell can be included in a system for sequencing polynucleotides, and/or in a cartridge used in a system for sequencing polynucleotides. In various examples, a flow cell can comprise a first substrate; a second substrate; and/or an adhesive layer that couples the first substrate to the second substrate. The adhesive layer can comprise a first adhesive and a second adhesive. A flow channel can be at least partially defined by the first substrate on a flow channel first side, by the second substrate on a flow channel second side opposite the flow channel first side, and by the first adhesive between the first substrate and the second substrate. The first adhesive can be disposed between the flow channel and the second adhesive. In various examples, at least a portion of the first adhesive can be disposed radially inward relative to the second adhesive. In various examples, the second adhesive can completely surround the first adhesive.

In various examples, the first adhesive can comprise a biocompatible material and/or a pressure-sensitive adhesive. The second adhesive can comprise an epoxy. In various examples, at least one of the first substrate or the second substrate can comprise glass. In various examples, the first adhesive has a first bond strength and the second adhesive has a second bond strength, and the second bond strength can be greater than the first bond strength.

In various examples, a method can comprise coupling a first adhesive to a first substrate; coupling a second adhesive to a second substrate; coupling the first substrate to the second substrate, such that an adhesive layer is formed between the first substrate and the second substrate comprising the first adhesive and the second adhesive; and/or forming a flow channel between the first substrate and the second substrate defined by the first substrate on a flow channel first side, by the second substrate on a flow channel second side opposite the flow channel first side, and by the first adhesive between the first substrate and the second substrate. The first adhesive can be disposed between the flow channel and the second adhesive. The first adhesive has a first bond strength and the second adhesive has a second bond strength, and the second bond strength can be greater than the first bond strength. In response to coupling the first substrate to the second substrate, the first adhesive and the second adhesive can both be in contact with the first substrate and the second substrate. In response to coupling the first adhesive to the first substrate, the first substrate can comprise a surface area unoccupied by the first adhesive, wherein the surface area comprises a surface area shape that is complementary to a shape of the second adhesive on the second substrate, such that the second adhesive can be disposed within the surface area of the first substrate in response to coupling the first substrate to the second substrate. In various examples, the surface area on the first substrate can be surrounded by the first adhesive.

In various examples, a method can comprise coupling a first substrate to a second substrate via a first adhesive; and/or applying a second adhesive between the first substrate and the second substrate, such that the second adhesive contributes to the coupling of the first substrate and the second substrate. A flow channel can be disposed through the first adhesive, such that the first adhesive at least partially defines the flow channel. The first adhesive can be disposed between the flow channel and the second adhesive. The first adhesive has a first bond strength and the second adhesive has a second bond strength, and the second bond strength can be greater than the first bond strength. In various examples, applying the second adhesive between the first substrate and the second substrate can be in response to passing the second adhesive through a void in at least one of the first substrate or the second substrate. In such examples, in response to coupling the first substrate and the second substrate via the first adhesive, the flow cell can comprise an area between the first substrate and the second substrate in fluid connection with the void and unoccupied by the first adhesive, wherein the second adhesive can be applied into the area between the first substrate and the second substrate. In various examples, the method may further comprise curing the first adhesive and/or the second adhesive.

It is to be understood that any respective features/examples of each of the aspects of the disclosure as described herein can be implemented together in any appropriate combination, and that any features/examples from any one or more of these aspects can be implemented together with any of the features of the other aspect(s) as described herein in any appropriate combination to achieve the benefits as described herein.

### BRIEF DESCRIPTION OF DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures. Elements with like element numbering throughout the figures are intended to be the same.

FIG. 1A illustrates a cross-sectional view of a previously known flow cell taken along a plane.

FIGS. 1B and 1C illustrate cross-sectional views of the flow cell of FIG. 1A taken along plane B, which is perpendicular to the plane of FIG. 1A.

FIG. 2A illustrates a cross-sectional view of a flow cell taken along a plane, in accordance with various examples.

FIG. 2B illustrates a cross-sectional view of the flow cell of FIG. 2A taken along plane C, which is perpendicular to the plane of FIG. 2A, in accordance with various examples.

FIGS. 3A-3F illustrate cross-sectional views of flow cells comprising two adhesives, in accordance with various examples.

FIGS. 4A-4D illustrate steps for a method of forming a flow cell having two adhesives, in accordance with various examples.

FIGS. 5A and 5B illustrates steps for another method of forming a flow cell having two adhesives, in accordance with various examples.

FIG. 6 illustrates a block diagram for the method of FIGS. 4A-4D of forming a flow cell having two adhesives, in accordance with various examples.

FIG. 7 illustrates a block diagram for the method of FIGS. 5A and 5B of forming a flow cell having two adhesives, in accordance with various examples.

FIG. 8 illustrates a plot showing flow cell deflection for various adhesives as a function of adhesive bond width, in accordance with various examples.

### DETAILED DESCRIPTION

All ranges may include the upper and lower values, and all ranges and ratio limits disclosed herein may be combined. It is to be understood that unless specifically stated otherwise, references to “a,” “an,” and/or “the” may include one or more than one and that reference to an item in the singular may also include the item in the plural. Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item. Further, reference to, e.g., a “first” item and a “second” item does not mean that there are no intervening items, and such intervening items may be present.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the scope of the disclosure. Thus, the detailed description herein is presented for purposes of illustration only and not of limitation. For example, the steps recited in any of the method or process descriptions may be executed in any combination and/or order and are not necessarily limited to the order or combination presented. Furthermore, any reference to singular includes plural embodiments, and any reference to more than one component or step may include a singular component or step. Also, any reference to attached, fixed, connected, or the like may include permanent, removable, temporary, partial, full, and/or any other possible attachment option. Additionally, any reference to without contact (or similar phrases) may also include reduced contact or minimal contact.

Examples provided herein are related to devices including flow cells and methods of making the same.

For example, provided herein are methods of forming flow cells that comprise two substrates coupled together by an adhesive layer comprising a first adhesive and a second adhesive. A flow channel, through which a fluid can flow, can be disposed between and/or defined by the two substrates, and defined by the first adhesive between the substrates. The flow cell provided by the substrates coupled by the first and second adhesives can be used to flow fluid(s) over the oligonucleotides, e.g., fluids including target polynucleotides, polymerases, nucleotides, reagents, and the like. Therefore, the first adhesive, which at least partially defines the flow channel between the substrates, can be chemically compatible (e.g., unreactive) with the fluids within the flow channel. The second adhesive can be disposed in the adhesive layer between the two substrates, and the first adhesive can be disposed between the second adhesive and the flow channel. Therefore, the second adhesive can be separated from the flow channel by the first adhesive, such that fluids within the flow channel do not contact the second adhesive. The second adhesive can comprise a bond strength that is greater than the bond strength of the first adhesive. Thus, the second adhesive can provide greater mechanical or structural stability, which can mitigate the risk of damage to the flow cell caused by processing conditions (e.g., temperatures or pressures) during flow cell operation. For example, the structural stability afforded by the second adhesive can mitigate the risk of deflection by any part of a flow cell, and if deflection does occur, mitigating the risk of peeling between the adhesive layer and a substrate(s) or other like damage relating to failure of the adhesive layer to maintain the bond between, and the position of, the two substrates.

### Terms

Unless defined otherwise, all technical and scientific terms used herein have the same meaning as is commonly understood by one of ordinary skill in the art. The use of the term “including” as well as other forms, such as “include,” “includes,” and “included,” is not limiting. The use of the term “having” as well as other forms, such as “have,” “has,” and “had,” is not limiting. As used in this specification, whether in a transitional phrase or in the body of the claim, the terms “comprise(s)” and “comprising” are to be interpreted as having an open-ended meaning. That is, the above terms are to be interpreted synonymously with the phrases “having at least” or “including at least.” For example, when used in the context of a process, the term “comprising” means that the process includes at least the recited steps, but can include additional steps. When used in the context of a compound, composition, or device, the term “comprising” means that the compound, composition, or device includes at least the recited features or components, but can also include additional features or components.

The terms “substantially”, “approximately”, and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

As used herein, the term “nucleotide” is intended to mean a molecule that includes a sugar and at least one phosphate group, and in some examples also includes a nucleobase. A nucleotide that lacks a nucleobase can be referred to as “abasic.” Nucleotides include deoxyribonucleotides, modified deoxyribonucleotides, ribonucleotides, modified ribonucleotides, peptide nucleotides, modified peptide nucleotides, modified phosphate sugar backbone nucleotides, and mixtures thereof. Examples of nucleotides include adenosine monophosphate (AMP), adenosine diphosphate (ADP), adenosine triphosphate (ATP), thymidine monophosphate (TMP), thymidine diphosphate (TDP), thymidine triphosphate (TTP), cytidine monophosphate (CMP), cytidine diphosphate (CDP), cytidine triphosphate (CTP), guanosine monophosphate (GMP), guanosine diphosphate (GDP), guanosine triphosphate (GTP), uridine monophosphate (UMP), uridine diphosphate (UDP), uridine triphosphate (UTP), deoxyadenosine monophosphate (dAMP), deoxyadenosine diphosphate (dADP), deoxyadenosine triphosphate (dATP), deoxythymidine monophosphate (dTMP), deoxythymidine diphosphate (dTDP), deoxythymidine triphosphate (dTTP), deoxycytidine diphosphate (dCDP), deoxycytidine triphosphate (dCTP), deoxyguanosine monophosphate (dGMP), deoxyguanosine diphosphate (dGDP), deoxyguanosine triphosphate (dGTP), deoxyuridine monophosphate (dUMP), deoxyuridine diphosphate (dUDP), and deoxyuridine triphosphate (dUTP).

As used herein, the term “nucleotide” also is intended to encompass any nucleotide analogue which is a type of nucleotide that includes a modified nucleobase, sugar and/or phosphate moiety compared to naturally occurring nucleotides. Example modified nucleobases include inosine, xathanine, hypoxathanine, isocytosine, isoguanine, 2-aminopurine, 5-methylcytosine, 5-hydroxymethyl cytosine, 2-aminoadenine, 6-methyl adenine, 6-methyl guanine, 2-propyl guanine, 2-propyl adenine, 2-thiouracil, 2-thiothymine, 2-thiocytosine, 15-halouracil, 15-halocytosine, 5-propynyl uracil, 5-propynyl cytosine, 6-azo uracil, 6-azo cytosine, 6-azo thymine, 5-uracil, 4-thiouracil, 8-halo adenine or guanine, 8-amino adenine or guanine, 8-thiol adenine or guanine, 8-thioalkyl adenine or guanine, 8-hydroxyl adenine or guanine, 5-halo substituted uracil or cytosine, 7-methylguanine, 7-methyladenine, 8-azaguanine, 8-azaadenine, 7-deazaguanine, 7-deazaadenine, 3-deazaguanine, 3-deazaadenine or the like. As is known in the art, certain nucleotide analogues cannot become incorporated into a polynucleotide, for example, nucleotide analogues such as adenosine 5′-phosphosulfate. Nucleotides can include any suitable number of phosphates, e.g., three, four, five, six, or more than six phosphates.

As used herein, the term “polynucleotide” refers to a molecule that includes a sequence of nucleotides that are bonded to one another. A polynucleotide is one nonlimiting example of a polymer. Examples of polynucleotides include deoxyribonucleic acid (DNA), ribonucleic acid (RNA), locked nucleic acid (LNA), peptide nucleic acid (PNA), and analogues thereof. A polynucleotide can be a single stranded sequence of nucleotides, such as RNA or single stranded DNA, a double stranded sequence of nucleotides, such as double stranded DNA, DNA that is folded to form a hairpin that is partially single stranded and partially double stranded, double-stranded amalgamations in which there are molecules that are non-covalently coupled to one another (e.g., via reversible hydrogen binding), and/or can include a mixture of a single stranded and double stranded sequences of nucleotides. Double stranded DNA (dsDNA) includes genomic DNA, and PCR and amplification products. Single stranded DNA (ssDNA) can be converted to dsDNA and vice-versa. Polynucleotides can include non-naturally occurring DNA, such as enantiomeric DNA. The precise sequence of nucleotides in a polynucleotide can be known or unknown. The following are examples of polynucleotides: a gene or gene fragment (for example, a probe, primer, expressed sequence tag (EST) or serial analysis of gene expression (SAGE) tag), genomic DNA, genomic DNA fragment, exon, intron, messenger RNA (mRNA), transfer RNA, ribosomal RNA, ribozyme, cDNA, recombinant polynucleotide, synthetic polynucleotide, branched polynucleotide, plasmid, vector, isolated DNA of any sequence, isolated RNA of any sequence, nucleic acid probe, primer or amplified copy of any of the foregoing.

As used herein, the term “target polynucleotide” is intended to mean a polynucleotide that is the object of an analysis or action. The analysis or action includes subjecting the polynucleotide to amplification, sequencing, and/or other procedure. A target polynucleotide can include nucleotide sequences additional to a target sequence to be analyzed. For example, a target polynucleotide can include one or more adapters, including an adapter that functions as a primer binding site, that flank(s) a target polynucleotide sequence that is to be analyzed. A target polynucleotide hybridized to a capture primer can include nucleotides that extend beyond the 5′ or 3′ end of the capture oligonucleotide in such a way that not all of the target polynucleotide is amenable to extension. In particular examples, target polynucleotides can have different sequences than one another but can have first and second adapters that are the same as one another. The two adapters that can flank a particular target polynucleotide sequence can have the same sequence as one another, or complementary sequences to one another, or the two adapters can have different sequences. Thus, species in a plurality of target polynucleotides can include regions of known sequence that flank regions of unknown sequence that are to be evaluated by, for example, sequencing (e.g., SBS). In some examples, target polynucleotides carry an adapter at a single end, and such adapter can be located at either the 3′ end or the 5′ end the target polynucleotide. Target polynucleotides can be used without any adapter, in which case a primer binding sequence can come directly from a sequence found in the target polynucleotide.

The terms “polynucleotide” and “oligonucleotide” are used interchangeably herein. The different terms are not intended to denote any particular difference in size, sequence, or other property unless specifically indicated otherwise. For clarity of description the terms can be used to distinguish one species of polynucleotide from another when describing a particular method or composition that includes several polynucleotide species.

As used herein, a “polymerase” is intended to mean an enzyme having an active site that assembles polynucleotides by polymerizing nucleotides into polynucleotides. A polymerase can bind a primed single stranded target polynucleotide, and can sequentially add nucleotides to the growing primer to form a “complementary copy” polynucleotide having a sequence that is complementary to that of the target polynucleotide. Another polymerase, or the same polymerase, then can form a copy of the target nucleotide by forming a complementary copy of that complementary copy polynucleotide. DNA polymerases can bind to the target polynucleotide and then move down the target polynucleotide sequentially adding nucleotides to the free hydroxyl group at the 3′ end of a growing polynucleotide strand (growing amplicon). DNA polymerases can synthesize complementary DNA molecules from DNA templates and RNA polymerases can synthesize RNA molecules from DNA templates (transcription). Polymerases can use a short RNA or DNA strand (primer), to begin strand growth. Some polymerases can displace the strand upstream of the site where they are adding bases to a chain. Such polymerases can be said to be strand displacing, meaning they have an activity that removes a complementary strand from a template strand being read by the polymerase. Example polymerases having strand displacing activity include, without limitation, the large fragment of Bst (Bacillus stearothermophilus) polymerase, exo-Klenow polymerase or sequencing grade T7 exo-polymerase. Some polymerases degrade the strand in front of them, effectively replacing it with the growing chain behind (5′ exonuclease activity). Some polymerases have an activity that degrades the strand behind them (3′ exonuclease activity). Some useful polymerases have been modified, either by mutation or otherwise, to reduce or eliminate 3′ and/or 5′ exonuclease activity.

As used herein, the term “primer” refers to a polynucleotide to which nucleotides can be added via a free 3′ OH group. The primer length can be any suitable number of bases long and can include any suitable combination of natural and non-natural nucleotides. A target polynucleotide can include an “adapter” that hybridizes to (has a sequence that is complementary to) a primer, and can be amplified so as to generate a complementary copy polynucleotide by adding nucleotides to the free 3′ OH group of the primer. A “capture primer” refers to a primer that is coupled to a substrate. In some examples, capture primers are P5 and P7 primers that are commercially available from Illumina, Inc. (San Diego, CA). In some examples, primers (such as primers or P5 or P7 primers) include a linker or spacer at the 5′ end. Such linker or spacer can be included in order to permit chemical or enzymatic cleavage, or to confer some other desirable property, for example to enable covalent attachment to a substrate, or to act as spacers to position a site of cleavage an optimal distance from the solid support. In certain cases, 10 spacer nucleotides can be positioned between the point of attachment of the P5 or P7 primers to a polymer or a solid support. In some examples, polyT spacers are used, although other nucleotides and combinations thereof can also be used. In one example, the spacer is a 6T to 10T spacer. In some examples, the linkers include cleavable nucleotides including a chemically cleavable functional group such as a vicinal diol or allyl T.

As used herein, the term “amplicon,” when used in reference to a polynucleotide, is intended to mean a product of copying the polynucleotide, wherein the product has a nucleotide sequence that is substantially the same as, or is substantially complementary to, at least a portion of the nucleotide sequence of the polynucleotide. “Amplification” and “amplifying” refer to the process of making an amplicon of a polynucleotide. A first amplicon of a target polynucleotide can be a complementary copy. Additional amplicons are copies that are created, after generation of the first amplicon, from the target polynucleotide or from the first amplicon. A subsequent amplicon can have a sequence that is substantially complementary to the target polynucleotide or is substantially identical to the target polynucleotide. It will be understood that a small number of mutations (e.g., due to amplification artifacts) of a polynucleotide can occur when generating an amplicon of that polynucleotide.

As used herein, the term “substrate” refers to a material that includes a solid support. A substrate can include a polymer that defines the solid support, or that is disposed on the solid support. Example substrate materials can include glass, silica, plastic, quartz, metal, metal oxide, organo-silicate (e.g., polyhedral organic silsesquioxanes (POSS)), polyacrylates, tantalum oxide, complementary metal oxide semiconductor (CMOS), or combinations thereof. An example of POSS can be that described in Kehagias et al., Microelectronic Engineering 86 (2009), pp. 776-778, which is incorporated by reference in its entirety. Illustratively, POSS-containing monomers can be polymerised reaching a gel-point rapidly to furnish a POSS resin (a polymer functionalized to include POSS) on which soft material functionalisation can be performed. In some examples, substrates used in the present application include silica-based substrates, such as glass, fused silica, or other silica-containing material. In some examples, substrates can include silicon, silicon nitride, or silicone hydride. In some examples, substrates used in the present application include plastic materials or components such as polyethylene, polystyrene, poly(vinyl chloride), polypropylene, nylons, polyesters, polycarbonates, and poly(methyl methacrylate). Example plastics materials include poly(methyl methacrylate), polystyrene, cyclic olefin copolymer, and cyclic olefin polymer substrates. In some examples, the substrate is or includes a silica-based material or plastic material or a combination thereof. In particular examples, the substrate has at least one surface comprising glass or a silicon-based polymer. In some examples, the substrates can include a metal. In some such examples, the metal is gold. In some examples, the substrate has at least one surface comprising a metal oxide. In one example, the surface comprises a tantalum oxide or tin oxide. Acrylamides, enones, or acrylates can also be utilized as a substrate material or component. Other substrate materials can include, but are not limited to gallium arsenide, indium phosphide, aluminum, ceramics, polyimide, quartz, resins, polymers and copolymers. In some examples, the substrate and/or the substrate surface can be, or include, quartz. In some other examples, the substrate and/or the substrate surface can be, or include, semiconductor, such as GaAs or ITO. The foregoing lists are intended to be illustrative of, but not limiting to the present application. Substrates can comprise a single material or a plurality of different materials. Substrates can be composites or laminates. In some examples, the substrate comprises an organo-silicate material. Substrates can be flat, round, spherical, rod-shaped, or any other suitable shape. Substrates can be rigid or flexible. In some examples, a substrate is a bead or a flow cell.

In some examples, a substrate described herein forms at least part of a flow cell or is located in or coupled to a flow cell. Example flow cells and substrates for manufacture of flow cells that can be used in methods and compositions set forth herein include, but are not limited to, those commercially available from Illumina, Inc. (San Diego, CA).

As used herein, the term “flow channel” refers to an elongated, at least partially enclosed void or space through which a fluid can flow, e.g., through which a fluid can be directed. A flow channel can have a length, a width, and a height. The width and height, together, can define a cross-sectional area of the flow channel. The cross-section of the flow channel can have any suitable shape, e.g., can be completely curved, partially curved, a completely polygonal, or partially polygonal. Illustratively, the cross-section of the flow channel can be circular, oval, square, rectangular, or the like. The fluid can substantially fill the cross-sectional area of the flow channel. The fluid can flow along the length of the flow channel. A flow channel can be formed by a cover coupled to a substrate, or by coupling multiple substrates.

As used herein, the term “fluidic device” refers to a device that includes at least one flow channel, and optionally can include a plurality of flow channels.

As used herein, the term “polymer” refers to a molecule including many repeated subunits or recurring units. Non-limiting examples of polymer structures include linear, branched, or hyper-branched polymers. Non-limiting examples of linear polymers including block copolymers or random/statistical copolymers. Non-limiting examples of branched polymers include star polymers, star-shaped or star-block polymers including both hydrophobic and hydrophilic segments, H-shaped polymers including both hydrophobic and hydrophilic segments, dumbbell shaped polymers, comb polymers, brush polymers, dendronized polymers, ladders, and dendrimers. Polymers can be cross-linked, or lightly cross-linked. Polymers as described herein can be linear, branched, hyper-branched or dendritic. The polymers described herein can also be in the form of polymer nanoparticles. Other examples of polymer architectures include, but not limited to ring block polymers and coil-cycle-coil polymers. Polymers with more than one type of recurring unit can be arranged as block copolymers, random copolymers, or alternating copolymers, or mixtures thereof. The final copolymer structure can be in different architectures, including, for example, random copolymer, block copolymer, comb-shaped polymer or star-shaped polymer architectures. Different classes of polymer backbones include, but are not limited to, polyacrylamides, polyacrylates, polyurethanes, polysiloxanes, silicones, polyacroleins, polyphosphazenes, polyisocyanates, poly-ols, polysaccharides, polypeptides, and combinations thereof. In some examples, the polymer includes polyacrylamide backbone. In some other examples, the polymer includes polyacrylate backbone. In still some other examples, the polymer includes polyurethane backbone. In still some other examples, the polymer includes polyphosphazene backbone. In still some other examples, the polymer includes a dendrimer backbone. A polymer can include one or more moieties that can react with one or more other moieties to form a covalent bond.

### Fluidic Devices Including Hybrid Bonding, and Methods of Making the Same

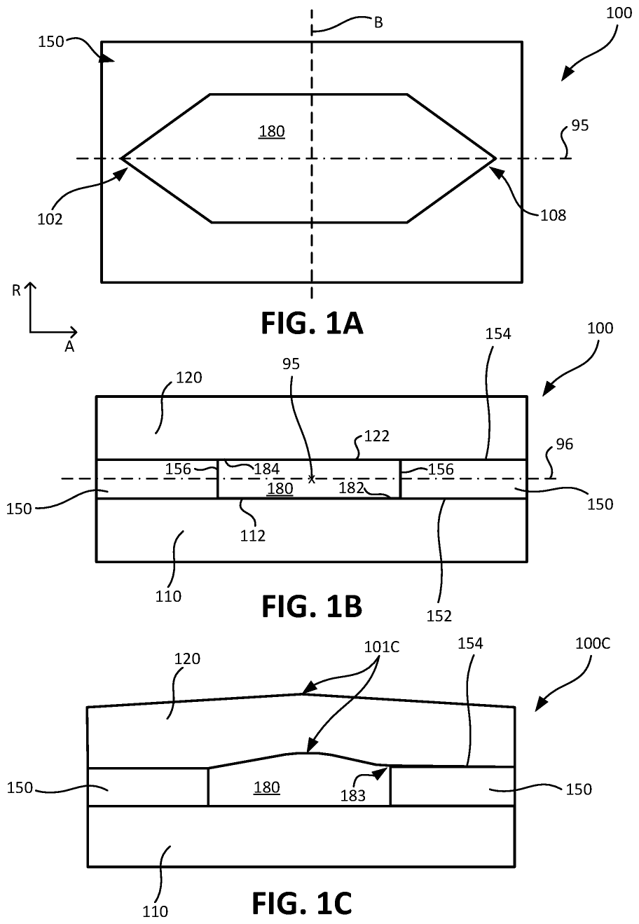

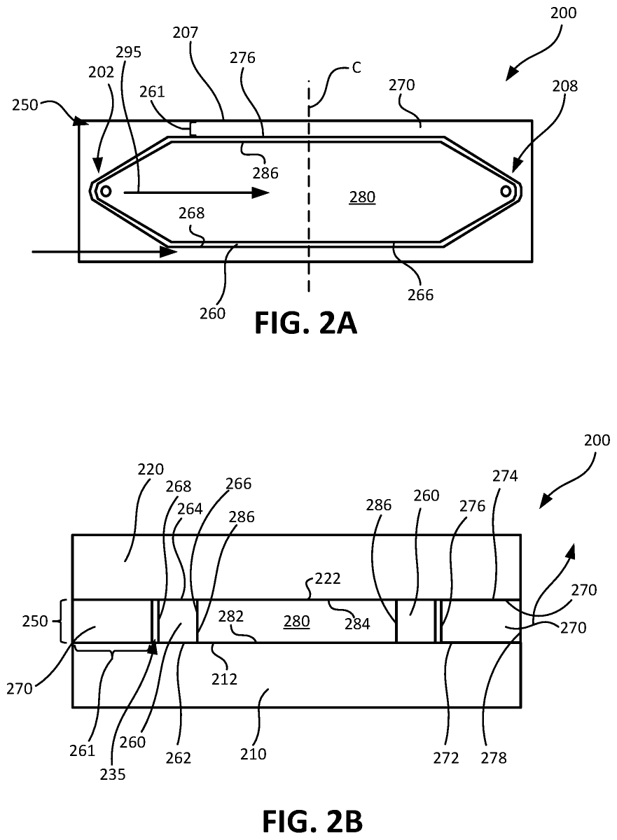

FIG. 1A illustrates a cross-sectional view of a previously known flow cell taken along a plane. FIGS. 1B and 1C illustrate cross-sectional views of the flow cell of FIG. 1A taken along plane B, which is perpendicular to the plane of FIG. 1A. With reference to FIGS. 1A-1C, an A-R axis has been included to illustrate the axial (A) and radial (R) directions. For clarity, axial axis A spans substantially parallel to axis 95. Thus, an “axial” direction, as used herein, means along or substantially parallel to axis 95 between ends of a flow channel (e.g., flow channel 180) through which fluid can flow. As used herein, the term “forward,” “front,” or the like refers to the direction of fluid flow within a flow channel (e.g., direction 295 shown in FIG. 2A). As used herein, the term “aft,” “rear,” or the like refers to the direction opposite of the direction of fluid flow within a flow channel. As utilized herein, radially “inward” or “inner” refers to the negative R direction towards axis 95 (e.g., substantially perpendicularly toward axis 95 and along or substantially parallel to axis 96), and radially “outward” or “outer” refers to the R direction away from axis 95 (e.g., substantially perpendicularly away from axis 95 along or substantially parallel to axis 96).

As noted above and as described in greater detail below, fluidic devices can include flow cells that are formed by coupling two substrates. Previously known flow cell 100 illustrated in FIG. 1A includes a first substrate 110 coupled to a second substrate 120 by an adhesive layer 150 disposed between substrates 110 and 120, as shown in FIG. 1B. A first adhesive side 152 of the adhesive layer 150 is coupled to a first side of 112 of first substrate 110, and a second adhesive side 154 of the adhesive layer 150 is coupled to a first side 122 of second substrate 120, as shown in FIG. 1B.

Flow channel 180 is defined on a flow channel first side 182 by first substrate 110, on a flow channel second side 184 by second substrate 120, and between the first substrate 110 and second substrate 120 by adhesive layer 150, as shown in FIG. 1B. That is, adhesive layer 150 at least partially surrounds flow channel 180 between first substrate 110 and second substrate 120. Fluids can flow through flow cell 100 and flow channel 180 therein from a first flow channel end 102 to a second flow channel end 108. Therefore, fluids within flow channel 180 can contact adhesive inner surface 156, which can be the radially inner surface of adhesive layer 150. Because adhesive layer 150 can come into contact with fluid and compounds disposed in and/or flowing through flow channel 180 (which may include compounds used in sequencing by synthesis such as nucleotides, polynucleotides, primers, and/or the like), the adhesive of adhesive layer 150 is selected to be nonreactive and/or compatible with such fluids and compounds (e.g., biocompatible), such that the adhesive in adhesive layer 150 may not contaminate, degrade, react with, or otherwise change the fluids within flow channel 180 and any compounds therein (such fluid or compound-compatible adhesives shall be referred to herein as “compatible adhesives” or “compatible materials”). In some examples, the adhesive of adhesive layer 150 can include a pressure-sensitive adhesive (PSA). However, compatible adhesives can have bond strengths that are lower than bond strengths of other adhesives, such as epoxies or the like.

In operation, fluid flowing through flow channel 180 (FIGS. 1B and 1C) can be pressurized to any suitable level and occur under any suitable temperatures. Under such conditions, an outward force from the flow channel can occur on one or more of the substrates in a flow cell. For example, as shown in FIG. 1C, an outward force on second substrate 120 from within flow channel 180 can occur in response to the pressure and/or temperature at which fluid is flowing within and through flow channel 180. Such outward force can cause one or more substrates to deflect. For example, second substrate 120 (FIG. 1B), or first side 122 thereof (FIG. 1B), can deflect or bow outwardly, shown by deflection 101C (FIG. 1C). Such deflection can cause separation or peel between the deflecting substrate and the adhesive layer coupling the substrates. As shown in FIG. 1C, outward deflection 101C of second substrate 120 can cause separation or peel between second substrate 120 and second adhesive side 154 of adhesive layer 150 at position 183 (where second substrate 120, adhesive layer 150, and flow channel 180 converge). Such substrate deflection and resulting peel from the adhesive layer can compromise the flow cell and render the flow cell inoperable or unusable (e.g., because of leakage from the flow channel).

As provided herein, to prevent or mitigate the risk of separation or peel between substrates and adhesives coupling such substrates in a flow cell, an adhesive layer can include both a compatible adhesive and an adhesive with a stronger bond strength (e.g., including a stronger cohesive strength, shear strength, peel strength, tensile strength, compression strength, increased rigidity, and/or the like) than that of the compatible adhesive. In some examples, a flow cell can have an adhesive layer that provides hybrid bonding between the substrates. FIG. 2A illustrates a cross-sectional view of a flow cell taken along a plane, in accordance with various examples. FIG. 2B illustrates a cross-sectional view of the flow cell of FIG. 2A taken along plane C, which is perpendicular to the plane of FIG. 2A, in accordance with various examples. With reference to FIGS. 2A-2B, a flow cell 200 can include an adhesive layer 250 coupling substrates together (e.g., first substrate 210 and second substrate 220) having a first adhesive 260 and a second adhesive 270. First substrate 210 (or first side 212 thereof) can be coupled to a first adhesive first side 262 of first adhesive 260 and/or a second adhesive first side 272 of second adhesive 270. Second substrate 220 (or first side 222 thereof) can be coupled to first adhesive second side 264 of first adhesive 260 and/or second adhesive second side 274 of second adhesive 270. In various examples, an adhesive layer can be coupled to and/or disposed between the surfaces of the first and second substrates that are most proximate to one another. In various examples, first adhesive 260 and second adhesive 270 can be disposed on or along the same plane. In various examples, first adhesive 260 and second adhesive 270 may be disposed on or along different planes.

The substrates in a flow cell can comprise any suitable material. In some examples, first substrate 210 and/or second substrate 220 (FIG. 2B) can include at least one of cyclic olefin polymer (COP), cyclic olefin copolymer (COC), glass, silicon, polypropylene (PP), photoresist, polyethylene terephthalate (PET), poly(N-(5-azidoacetamidylpentyl) acrylamide-co-acrylamide) (PAZAM), and polyethylene (PE). In some examples, first substrate 210 can comprise any of the forgoing materials, and second substrate 220 can comprise at least one of cyclic olefin polymer (COP), cyclic olefin copolymer (COC), glass, silicon, polypropylene (PP), photoresist, polyethylene terephthalate (PET), poly(N-(5-azidoacetamidylpentyl) acrylamide-co-acrylamide) (PAZAM), and polyethylene (PE). In some examples, first substrate 210 can comprise silicon. In some examples, second substrate 220 can comprise glass.

In various examples, as shown in FIGS. 2A and 2B flow cell 200 can include a flow channel 280 (similar to flow channel 180 of flow cell 100 (FIG. 1B)) defined by first substrate 210, second substrate 220, and adhesive layer 250 between first substrate 210 and second substrate 220. Flow channel 280 may span axially between first flow channel end 202 and second flow channel end 208. In various examples, flow channel 280 can be defined at least partially by first substrate 210 on a flow channel first side 282, at least partially by second substrate 220 on a flow channel second side 284 opposite flow channel first side 282, and at least partially by adhesive layer 250 between first substrate 210 and second substrate 220. In some examples, a first substrate and/or a second substrate of a flow cell can define at least a portion of multiple sides of a flow channel.

In various examples, as shown in FIGS. 2A and 2B, at least a portion of first adhesive 260 of adhesive layer 250 can be disposed radially inward of second adhesive 270. In various examples, at least a portion of first adhesive 260 can be disposed between flow channel 280 and second adhesive 270. Accordingly, at least a portion of first adhesive 260, or a radially inward surface 266 thereof, can be adjacent to, and at least partially define, flow channel 280. First adhesive 260 can separate flow channel 280 and any fluid flowing therethrough from second adhesive 270. Thus, of first adhesive 260 and second adhesive 270, fluid within flow channel 280 may only contact first adhesive 260.

In various examples, as shown in FIGS. 2A and 2B, first adhesive 260 can have an abutting surface 268. First adhesive abutting surface 268 can be a surface that is proximate and/or adjacent to second adhesive 270 (or a second adhesive abutting surface 276). Second adhesive abutting surface 276 can be a surface that is proximate and/or adjacent to first adhesive 260. In various examples, the abutting surfaces of first adhesive 260 and second adhesive 270 can be adjacent to or abutting one another (e.g., having substantially no space or area therebetween). In various examples, the abutting surfaces of first adhesive 260 and second adhesive 270 can be spaced apart leaving an adhesive layer space 235 between first adhesive 260 and second adhesive 270.

In various examples, as shown in FIGS. 2A and 2B, first adhesive 260 can include a compatible adhesive and/or compatible material. For example, first adhesive 260 can include a material that is biocompatible and/or nonreactive with fluids and compounds flowing through flow channel 280. Accordingly, fluids flowing through flow channel 280 can contact first adhesive 260 without first adhesive 260 reacting with, degrading, contaminating, or otherwise altering such fluids or compounds therein. In various examples, first adhesive 260 can include a pressure-sensitive adhesive.

First adhesive 260 (FIG. 2B) including such compatible material(s) (e.g., a pressure-sensitive adhesive), as discussed herein, can have a first bond strength (e.g., a first cohesive strength, shear strength, peel strength, tensile strength, compression strength, and/or rigidity level). Such first bond strength provides bonding between substrates in a flow cell that can be insufficient to adequately prevent separation between the substrates and/or between one or more of the substrates and the first adhesive.

Accordingly, as shown in FIGS. 2A and 2B, in various examples of this disclosure, second adhesive 270 of adhesive layer 250 may have a second bond strength (e.g., a second cohesive strength, shear strength, peel strength, tensile strength, compression strength, and/or rigidity level). The second bond strength of second adhesive 270 can be greater than the first bond strength of first adhesive 260. For example, the first bond strength of first adhesive 260 may have a cohesive strength, shear strength, peel strength, tensile strength, compression strength, and/or rigidity level that is less than that of second adhesive 270. In various examples, second adhesive 270 may include a polymeric material, such as an epoxy, polyurethane, polyimide, and/or the like. Second adhesive 270 may not necessarily be compatible with fluids flowing through flow channel 280. For at least this reason, as discussed herein, second adhesive 270 can be separated from flow channel 280 and the fluids therein by first adhesive 260. Thus, flow cell 200 having first adhesive 260 and second adhesive 270 coupling first substrate 210 and second substrate 220, in accordance with various examples of this disclosure, receive the benefit of first adhesive 260 being compatible with fluids and compounds flowing through flow channel 280 and contacting first adhesive 260, and the benefit of greater structural and mechanical stability and bonding strength between adhesive layer 250, first substrate 210, and/or second substrate 220.

The first adhesive and second adhesive within a flow cell can be disposed in any suitable structure or arrangement, with at least a portion of the first adhesive being disposed between the second adhesive and the flow channel. In various examples, within a flow cell, all of the second adhesive may be separated from the flow channel by the first adhesive. For example, with reference to flow cell 200 in FIGS. 2A and 2B, first adhesive 260 may form a perimeter at least partially surrounding flow channel 280 between first substrate 210 and second substrate 220, with second adhesive 270 being disposed in at least a portion of the remaining space between first adhesive 260 and an outer boundary 207 of flow cell 200, between first substrate 210 and second substrate 220 (e.g., second adhesive 270 being radially outward of first adhesive 260 and forward and aft of first adhesive 260).

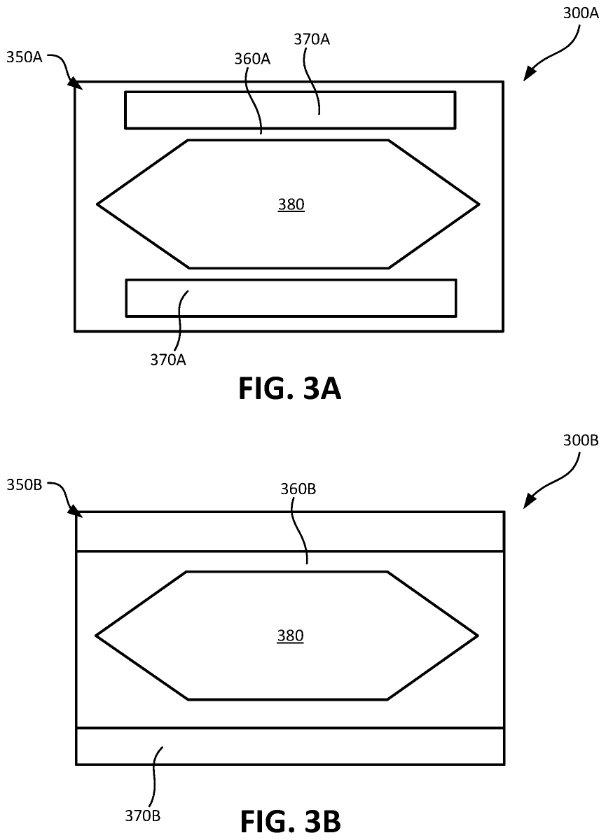

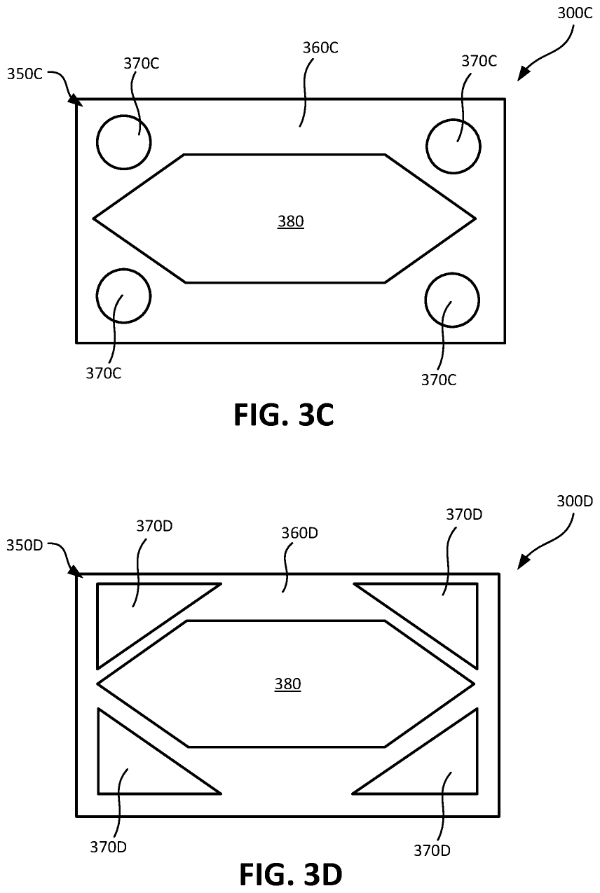

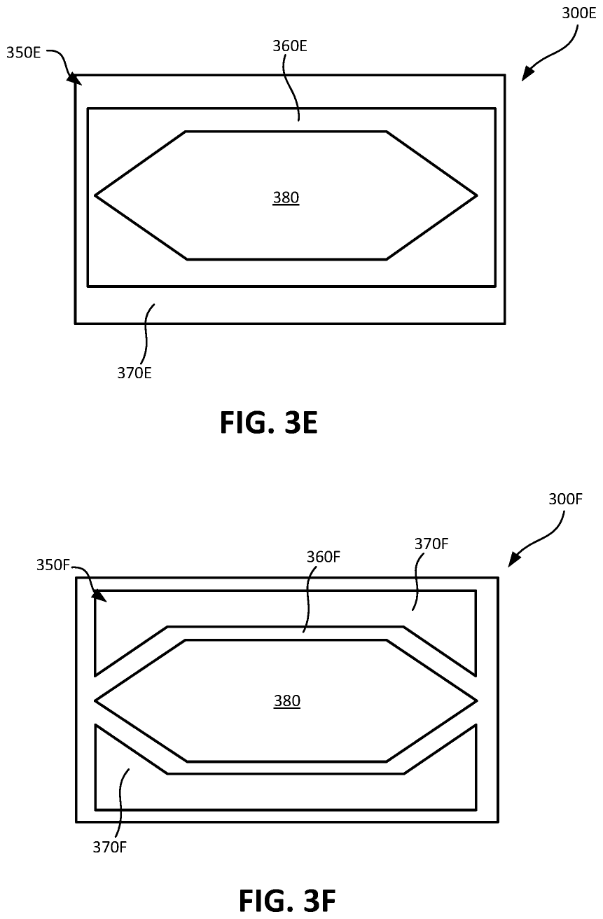

With reference to FIGS. 3A and 3B, a flow cell may include portions of the second adhesive disposed radially outward the first adhesive, on one or both radial sides (and not directly forward or aft of the first adhesive). For example, flow cell 300A of FIG. 3A includes an adhesive layer 350A having second adhesive portions 370A radially outward of the portion of first adhesive 360A adjacent to flow channel 380, with first adhesive 360A surrounding second adhesive portions 370A. As another example, flow cell 300B of FIG. 3B includes an adhesive layer 350B having second adhesive portions 370B radially outward of first adhesive 360B adjacent to flow channel 380.

With reference to FIGS. 3D and 3E, a flow cell may include portions of the second adhesive in positions spaced around the first adhesive. For example, portions of the second adhesive may be disposed in corner portions of a flow cell radially outward of flow channel ends. In various examples, the portions of the second adhesive can be at least partially surrounded by the first adhesive. The portions of the second adhesive can be any suitable shape. For example, flow cell 300C of FIG. 3C includes an adhesive layer 350C having circular second adhesive portions 370C disposed in corner areas of flow cell 300C (e.g., on each side radially outward of the first and second ends of flow channel 380), with first adhesive 360C surrounding second adhesive portions 370C. As another example, flow cell 300D of FIG. 3D includes an adhesive layer 350D having triangular second adhesive portions 370D disposed in corner areas of flow cell 300D (e.g., on each side radially outward of the first and second ends of flow channel 380), with first adhesive 360D surrounding second adhesive portions 370D. Triangular second adhesive portions 370D can include at least one surface shaped or spanning in a direction complementary to a portion of the shape of flow channel 380.

With reference to FIGS. 3E and 3F, a flow cell can include a second adhesive (or portions thereof) disposed radially outward the first adhesive at least along the full length of the flow channel. For example, flow cell 300E of FIG. 3E includes an adhesive layer 350E having second adhesive 370E surrounding first adhesive 360E (i.e., second adhesive 370E is disposed radially outward, forward, and aft of first adhesive 360E). As another example, flow cell 300F of FIG. 3F includes an adhesive layer 350F having two separate second adhesive portions 370F radially outward of first adhesive 360F and spanning the axial length of flow channel 380.

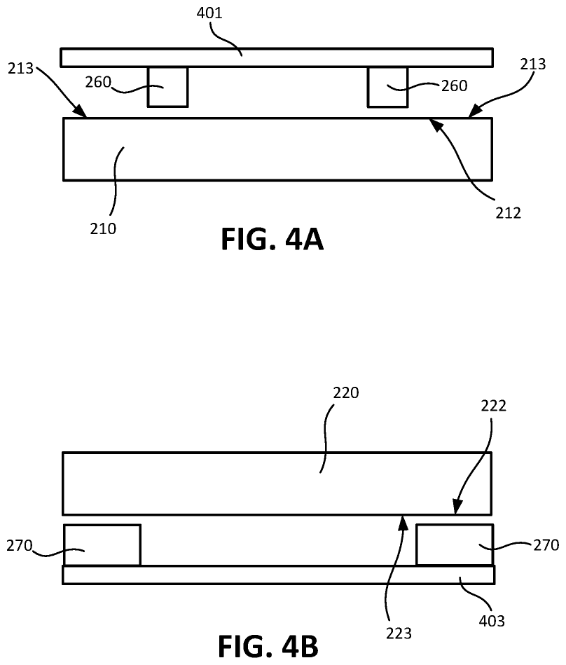

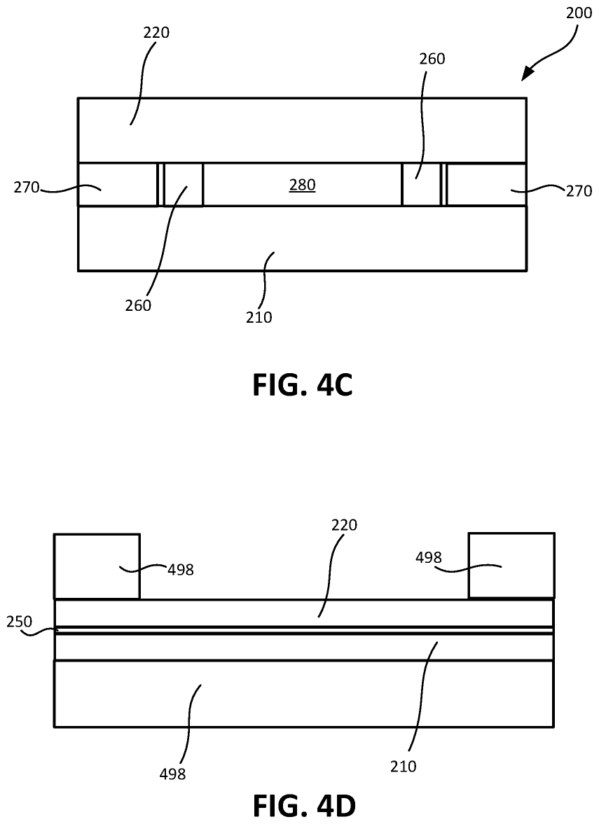

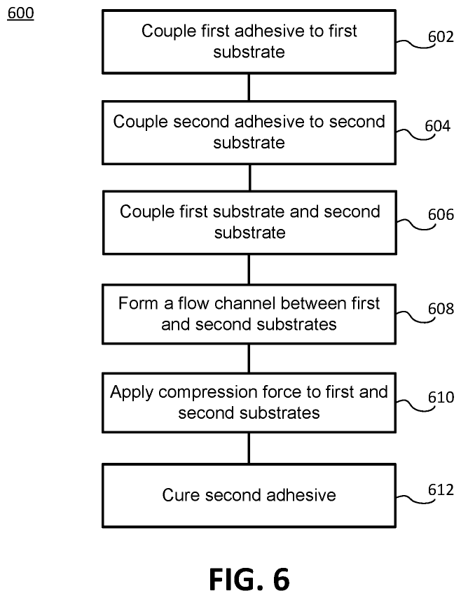

A flow cell in accordance with various examples of this disclosure can be made in any suitable manner. With reference to FIGS. 4A-4D and FIG. 6, a method 600 of a making a flow cell is depicted. In various examples, a first adhesive 260 can be coupled to a first substrate 210 (step 602), for example, as depicted in FIG. 4A. First adhesive 260 can be coupled to first substrate 210 in any suitable manner. For example, first adhesive 260 can be coupled to a liner 401, and then applied to first substrate 210 (e.g., by compressing or otherwise contacting first adhesive 260 on first substrate 210). As another example, first adhesive 260 may be coupled or applied directly to first substrate 210. First adhesive 260 can be coupled to first substrate 210 at a desired position on first substrate 210, such that there is a surface area 213 of first substrate 210 (or on first substrate first side 212) unoccupied by first adhesive 260. Such surface area 213 can be radially outward of at least a portion of first adhesive 260.

Continuing with method 600, in various examples, a second adhesive 270 can be coupled to a second substrate 220 (step 604) for example, as depicted in FIG. 4B. Second adhesive 270 can be coupled to second substrate 220 in any suitable manner. For example, second adhesive 270 can be coupled to a liner 403, and then applied to second substrate 220 (e.g., by compressing or otherwise contacting second adhesive 270 on second substrate 220). As another example, second adhesive 270 may be coupled or applied directly to second substrate 220. Second adhesive 270 may be coupled to second substrate 220 at a desired position on second substrate 220, such that there is a surface area 223 of second substrate 220 (or on second substrate first side 222) unoccupied by second adhesive 270. Such surface area 223 can be radially inward of at least a portion of second adhesive 270.

In various examples, first substrate 210 and second substrate 220 (FIGS. 4A-4D) can be coupled (step 606) (FIG. 6). In response, an adhesive layer 250 is formed between first substrate 210 and second substrate 220 including first adhesive 260 and second adhesive 270. First adhesive 260 and second adhesive 270 can span between and can be in contact with and coupled to both first substrate 210 and second substrate 220 (i.e., first adhesive 260 and second adhesive 270 may have substantially the same thickness). Surface area 213 on first substrate 210 unoccupied by first adhesive 260 may have a shape that is complementary to the shape of second adhesive 270 disposed on second substrate 220, such that second adhesive 270 can be disposed within surface area 213. Similarly, at least a portion of surface area 223 on second substrate 220 unoccupied by second adhesive 270 may have a shape that is complementary to the shape of first adhesive 260 disposed on first substrate 210, such that first adhesive 260 can be disposed within surface area 223. Second adhesive 270 may be radially outward of at least a portion of first adhesive 260. In various examples, such as those discussed herein, the first adhesive of the adhesive layer may completely surround the second adhesive or portions thereof. In various examples, such as those discussed herein, the second adhesive of the adhesive layer may completely surround the first adhesive or portions thereof.

In various examples, in response to coupling first substrate 210 and second substrate 220 and forming adhesive layer 250, a flow channel 280 can be formed between first substrate 210 and second substrate 220 (step 608) (FIG. 6). As discussed herein, flow channel 280 may be at least partially defined by first substrate 210, second substrate 220, and first adhesive 260 between first substrate 210 and second substrate 220. First adhesive 260 may completely surround flow channel 280 between first substrate 210 and second substrate 220. At least a portion of first adhesive 260 may be disposed between flow channel 280 and second adhesive 270. Accordingly, of first adhesive 260 and second adhesive 270, fluids within flow channel 280 may only contact first adhesive 260.

In various examples, continuing with method 600, a compression force may be applied to first substrate 210 and second substrate 220 (step 610), compressing first substrate 210 and second substrate 220 toward one another. As shown in FIG. 4D, clamp 498 may be applied to provide compression force, pushing first substrate 210 and second substrate 220 toward one another. Such compression force may facilitate or cause first adhesive 260 and/or second adhesive 270 to bind or adhere to first substrate 210 and/or second substrate 220 (or strengthen the bonding thereto).

In various examples, second adhesive 270 (FIG. 4B) may be cured (step 612) (FIG. 6). For example, second adhesive 270 can include an epoxy or other material that can be cured by any suitable method (e.g., application of heat, ultraviolet light, etc.).

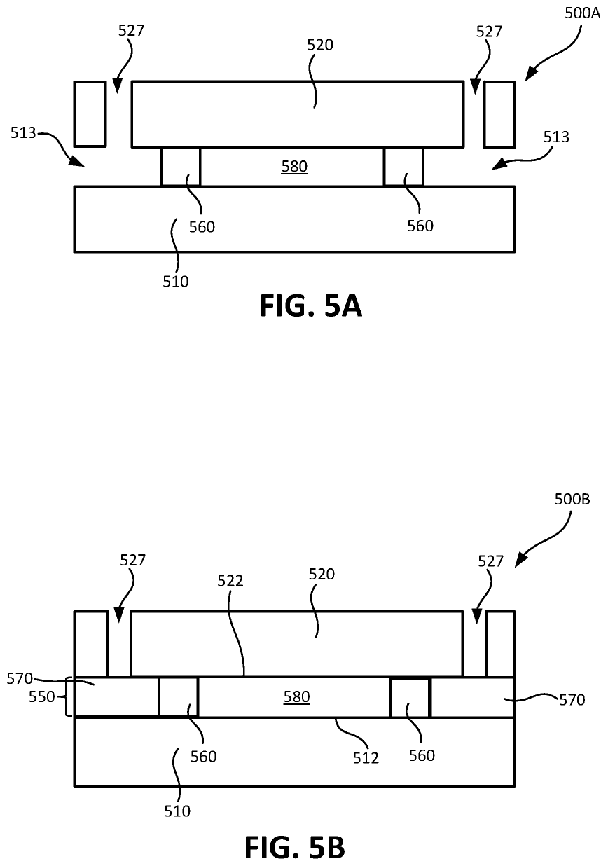

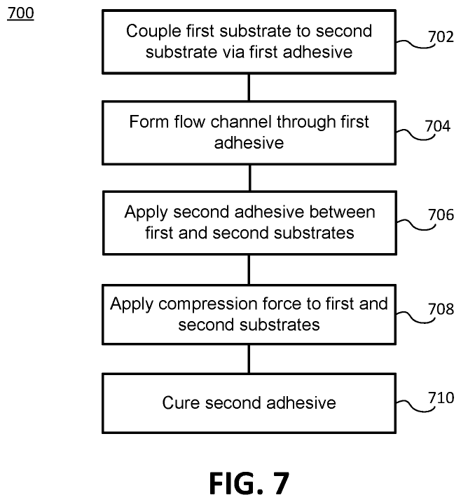

With reference to FIGS. 5A and 5B and FIG. 7, another method 700 of a making a flow cell is depicted. In various examples, first substrate 510 (similar to first substrate 210, discussed herein) and second substrate 520 (similar to second substrate 220, discussed herein) can be coupled together by a first adhesive 560 (similar to first adhesive 260, discussed herein) (step 702), as depicted in FIG. 5A. First substrate 510 and second substrate 520 can be coupled by first adhesive 560 in any suitable manner. For example, first substrate 510 and second substrate 520 can be compressed together with first adhesive 560 therebetween (which can cause a pressure-sensitive adhesive of first adhesive 560 to activate and bind the substrates). First adhesive 560 can be coupled to first substrate 510 and second substrate 520 at a desired position between first substrate 510 and second substrate 520, such that there is an area 513 between first substrate 510 and second substrate 520 unoccupied by first adhesive 560. Such area 513 can be radially outward of at least a portion of first adhesive 560.

In various examples, a flow channel 580 can be formed through first adhesive 560 (step 704) between first substrate 510 and second substrate 520. Flow channel 580 (similar to flow channel 280) may be at least partially defined by first substrate 510, second substrate 520, and first adhesive 560 between first substrate 510 and second substrate 520. First adhesive 560 may completely surround flow channel 580 between first substrate 510 and second substrate 520. At least a portion of first adhesive 560 may be disposed between flow channel 580 and area 513.

In various examples, a second adhesive 570 may be applied between first substrate 510 and second substrate 520 (step 706). In various examples, second adhesive 580 may be disposed or applied into areas 513, forming adhesive layer 550 including first adhesive 560 and second adhesive 570 between first substrate 510 and second substrate 520. Second adhesive 580 may contribute to the coupling between first substrate 510 and second substrate 520. First adhesive 560 may be disposed between flow channel 580 and second adhesive 570. Thus, of first adhesive 560 and second adhesive 570, fluids within flow channel 580 may only contact first adhesive 560.

In various examples, second adhesive 570 may be applied between first substrate 510 and second substrate 520 through a void(s) in at least one of first substrate 510 and second substrate 520. As shown in FIGS. 5A and 5B, voids 527 are disposed through second substrate 520. Voids 527 may be in fluid communication with areas 513, such that second adhesive 570 can be applied through voids 527 and disposed into areas 513. In response to second adhesive 570 being applied between first substrate 510 and second substrate 520, in various examples, voids 527 may be filled in with material (e.g., including second adhesive 570, the same material as second substrate 520, or any other suitable material).

In various examples, continuing with method 700, a compression force may be applied to first substrate 510 and second substrate 520 (step 708) (FIG. 7) toward one another, similar to step 610 of method 600, discussed above. In various examples, second adhesive 570 may be cured (step 710) (FIG. 7). For example, second adhesive 570 can include an epoxy or other material that can be cured by any suitable method (e.g., application of heat, ultraviolet light, etc.).

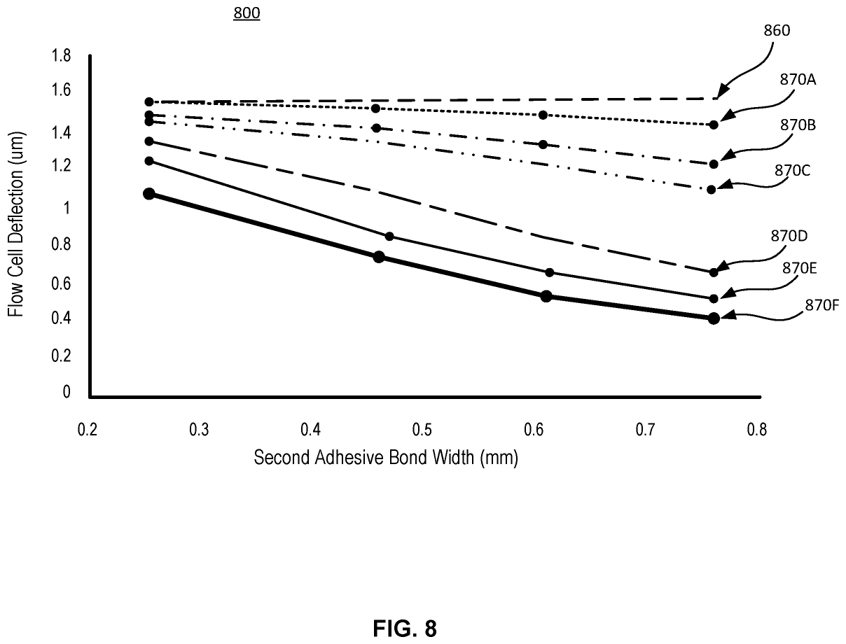

In various embodiments, the adhesive layer in a flow cell, according to various examples of this disclosure, can prevent or mitigate the risk of substrate deflection, and/or peeling or separation between the adhesive layer and one or more substrates. In some examples, the amount of substrate deflection may be dependent on, or a function of, the bond width of the second adhesive in the adhesive layer. Such bond width may be a radial bond width, for example, bond width 261 shown in FIGS. 2A and 2B. The plot chart in FIG. 8 shows the amount of flow cell or substrate deflection in micrometers (μm) (on the y-axis) during flow cell operation for different adhesives as a function of bond width (on the x-axis) (bond width being measured similar to bond width 261, as shown in FIGS. 2A and 2B) ranging from about 0.25 millimeter (mm) to 0.75 mm. A first adhesive 860 (which includes a pressure-sensitive adhesive) shows little or no improvement in substrate deflection over the range of bond widths thereof. Second adhesives 870A-870F are various adhesives including epoxy or other polymeric materials, which show significant decreases in flow cell deflection resulting from an increase in bond width. In various examples, the bond width of the second adhesive in a flow cell may be greater than 0.46 mm to achieve desired deflection mitigation results.

### Additional Comments

It is to be understood that any respective features/examples of each of the aspects of the disclosure as described herein can be implemented together in any appropriate combination, and that any features/examples from any one or more of these aspects can be implemented together with any of the features of the other aspect(s) as described herein in any appropriate combination to achieve the benefits as described herein.

While various illustrative examples are described above, it will be apparent to one skilled in the art that various changes and modifications can be made therein without departing from the invention. The appended claims are intended to cover all such changes and modifications that fall within the true spirit and scope of the invention.

What is claimed is:

1. A flow cell, comprising:
a first substrate;
a second substrate; and
an adhesive layer that couples the first substrate to the second substrate, wherein the adhesive layer comprises a first adhesive and a second adhesive,
wherein a flow channel is at least partially defined by the first substrate on a flow channel first side, by the second substrate on a flow channel second side opposite the flow channel first side, and by the first adhesive between the first substrate and the second substrate,
wherein the first adhesive is disposed between the flow channel and the second adhesive.

2. The flow cell of claim 1, wherein the first adhesive comprises a biocompatible material.

3. The flow cell of claim 1, wherein the first adhesive comprises a pressure-sensitive adhesive.

4. The flow cell of claim 1, wherein the second adhesive comprises an epoxy.

5. The flow cell of claim 1, wherein the first adhesive has a first bond strength and the second adhesive has a second bond strength, wherein the second bond strength is greater than the first bond strength.

6. The flow cell of claim 1, wherein at least a portion of the first adhesive is disposed radially inward relative to the second adhesive.

7. The flow cell of claim 1, wherein the second adhesive completely surrounds the first adhesive.

8. The flow cell of claim 1, wherein at least one of the first substrate or the second substrate comprises glass.

9. A cartridge for use in a system for sequencing polynucleotides, the cartridge comprising the flow cell of claim 1.

10. A system for sequencing polynucleotides, the system comprising the flow cell of claim 1.

11. A method of forming a flow cell, comprising:
coupling a first adhesive to a first substrate;
coupling a second adhesive to a second substrate;
coupling the first substrate to the second substrate, such that an adhesive layer is formed between the first substrate and the second substrate comprising the first adhesive and the second adhesive; and
forming a flow channel between the first substrate and the second substrate defined by the first substrate on a flow channel first side, by the second substrate on a flow channel second side opposite the flow channel first side, and by the first adhesive between the first substrate and the second substrate, and wherein the first adhesive is disposed between the flow channel and the second adhesive.

12. The method of claim 11, wherein, in response to the coupling the first substrate to the second substrate, the first adhesive and the second adhesive are both in contact with the first substrate and the second substrate.

13. The method of claim 12, wherein, in response to the coupling the first adhesive to the first substrate, the first substrate comprises a surface area unoccupied by the first adhesive, wherein the surface area comprises a surface area shape that is complementary to a shape of the second adhesive on the second substrate, such that the second adhesive is disposed within the surface area of the first substrate in response to the coupling the first substrate to the second substrate.

14. The method of claim 13, wherein the surface area on the first substrate is surrounded by the first adhesive.

15. The method of claim 13, wherein the first adhesive has a first bond strength and the second adhesive has a second bond strength, wherein the second bond strength is greater than the first bond strength.

16. A method of forming a flow cell, comprising:
coupling a first substrate to a second substrate via a first adhesive, wherein a flow channel is disposed through the first adhesive, such that the first adhesive at least partially defines the flow channel; and
applying a second adhesive between the first substrate and the second substrate, such that the second adhesive contributes to the coupling of the first substrate and the second substrate, wherein the first adhesive is disposed between the flow channel and the second adhesive.

17. The method of claim 16, wherein the applying the second adhesive between the first substrate and the second substrate is in response to passing the second adhesive through a void in at least one of the first substrate or the second substrate.

18. The method of claim 17, wherein, in response to the coupling the first substrate and the second substrate via the first adhesive, the flow cell comprises an area between the first substrate and the second substrate in fluid connection with the void and unoccupied by the first adhesive, wherein the second adhesive is applied into the area between the first substrate and the second substrate.

19. The method of claim 18, wherein the first adhesive has a first bond strength and the second adhesive has a second bond strength, wherein the second bond strength is greater than the first bond strength.

20. The method of claim 18, further comprising curing the second adhesive.
